(19) United States
(12) Patent Application Publication
(10) Pub. No.: US 2026/0014789 A1
(43) Pub. Date: Jan. 15, 2026

(54) CARRIER-TAPE THERMAL BONDING DEVICE

(71) Applicant: TOKYO WELD CO., LTD., Tokyo-to (JP)

(72) Inventor: Katsuyoshi KODERA, Tokyo-to (JP)

(73) Assignee: TOKYO WELD CO., LTD., Tokyo-to (JP)

(21) Appl. No.: 19/243,964

(22) Filed: Jun. 20, 2025

(30) Foreign Application Priority Data
Jul. 12, 2024 (JP) 2024-112734

(51) Int. Cl. B32B 37/22; B32B 37/06; B32B 37/08

(52) U.S. Cl. CPC B32B 37/22; B32B 37/06; B32B 37/08

(57) ABSTRACT

To securely thermal bond a top tape to a carrier tape. A carrier-tape thermal bonding device includes a heating device 40, and the heating device 40 includes a pair of heating elements 60, 60 positioned on both sides of a width direction of the cavity 13 of a carrier tape 7. A width W1 of a preheating area 61 of the heating element 60 is greater than a width W2 of a pressurizing area 62.

### TECHNICAL FIELD

The present invention relates to a carrier-tape thermal bonding device, in particular, a carrier-tape thermal bonding device suitable for high-speed processing.

### BACKGROUND ART

A workpiece taping system, which transports workpieces, inspects them, and transfers them into cavities in a carrier tape, has been conventionally known. After the workpieces have been transferred into the cavities, a top tape is positioned on the carrier tape, and the top tape is thermally bonded to the carrier tape. Such a thermal bonding device has a structure that swings a heating element downward around a rotation axis. However, such a thermal bonding device is difficult to perform high-speed processing.

[Patent Document 1] JP 2009-40475 A

### DISCLOSURE OF THE INVENTION

The present disclosure has been made in view of the above circumstances, and provides a carrier-tape thermal bonding device suitable for high-speed processing.

The present disclosure is a carrier-tape thermal bonding device that thermally bonds a top tape to a carrier tape including a cavity inside which a workpiece is accommodated, the carrier tape extending in a transport direction, the carrier-tape thermal bonding device comprising: a transport rail that is configured to hold the carrier tape and the top tape in a stacked condition, and includes a lower end portion; a heating device that is arranged above the transport rail to be opposed to and parallel to the transport rail and is configured to heat and press the top tape; and a pneumatic drive unit that has an upper end portion for supporting the lower end portion of the transport rail and is configured to move the transport rail upward and downward; wherein: the upper end portion of the drive unit has a concave surface that is curved when seen from the transport direction, the lower end portion of the transport rail having a convex surface that is curved when seen from the transport direction, and a plurality of rollers being interposed between the concave surface and the convex surface; the heating device includes at a lower end portion thereof a pair of heating elements positioned on both sides of a width direction of the cavity; the pair of heating elements are each divided into a preheating area and a pressurizing area formed in this order from an upstream side to a downstream side along the transport direction; and a length in the width direction of the preheating area of each heating element is greater than a length in the width direction of the pressurizing area.

The present disclosure is the carrier-tape thermal bonding device wherein a centerline of the preheating area along the transport direction of each heating element corresponds to a centerline of the pressurizing area along the transport direction.

The present disclosure is the carrier-tape thermal bonding device wherein a length in the transport direction of each of the pair of heating elements present in the preheating area is longer than a length in the transport direction of each of the pair of heating elements present in the pressurizing area.

The present disclosure is the carrier-tape thermal bonding device wherein the heating device is supported to be rotatable about a rotation shaft extending parallel to the transport direction, so that the heating device is rotatable between an operation position in which the pair of heating elements face downward, and a standby position in which the pair of heating elements face transversely.

The present disclosure is the carrier-tape thermal bonding device wherein a cooling channel that cools the rotation shaft is formed in the rotation shaft.

As described above, the present disclosure can provide the carrier-tape thermal bonding device suited for high-speed processing.

### BRIEF DESCRIPTION OF THE DRAWINGS

FIG. 1 is a front view showing a carrier-tape thermal bonding device according to the embodiment.

FIG. 2 is a side view showing the carrier-tape thermal bonding device according to the embodiment.

FIG. 3 is a perspective view showing the carrier-tape thermal bonding device according to the embodiment.

FIG. 4 is a schematic front view showing the carrier-tape thermal bonding device according to the embodiment.

FIG. 5 is an enlarged side view showing the carrier-tape thermal bonding device according to the embodiment.

FIG. 6 is a front view showing a pair of heating elements of a heating device.

FIG. 7 is a plan view showing a carrier tape.

FIG. 8 is a cross-sectional view showing the carrier tape.

FIG. 9 is a side view showing an entire workpiece taping system.

FIG. 10 is a schematic view showing the entire workpiece taping system.

FIG. 11 is a front view showing the heating elements of the heating device, each of which is present in a preheating area and a pressurizing area.

FIG. 12 is a bottom view showing the heating element of the heating device, which is present in the preheating area and the pressurizing area.

FIG. 13 is a view showing a rotation shaft which supports the heating device via a cover member, and a cooling channel formed in the rotation shaft.

FIG. 14 is an enlarged view showing a lower end surface of the heating body of the heating device.

### MODE FOR CARRYING OUT THE INVENTION

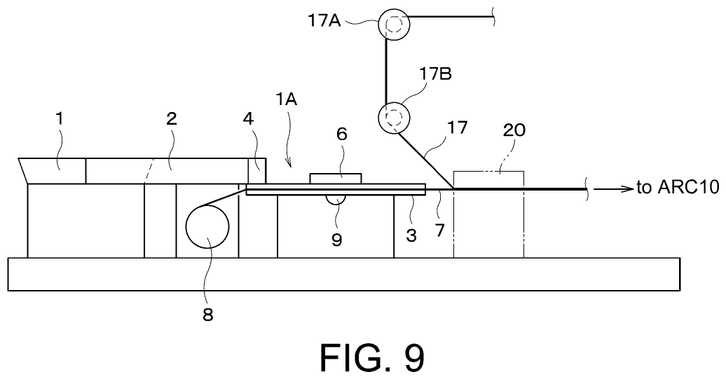

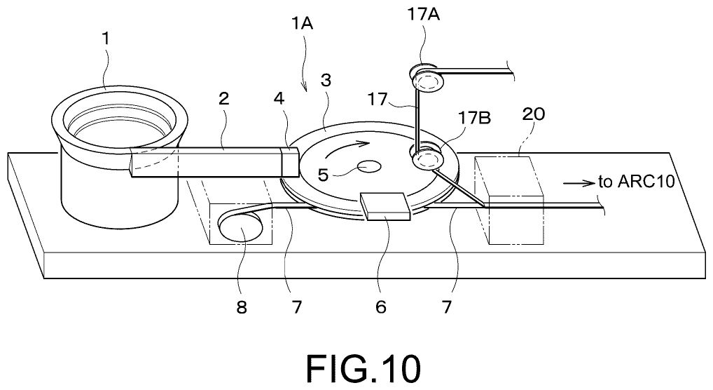

An entire workpiece taping system incorporating a carrier-tape thermal bonding device is described first with reference to FIGS. 9 and 10.

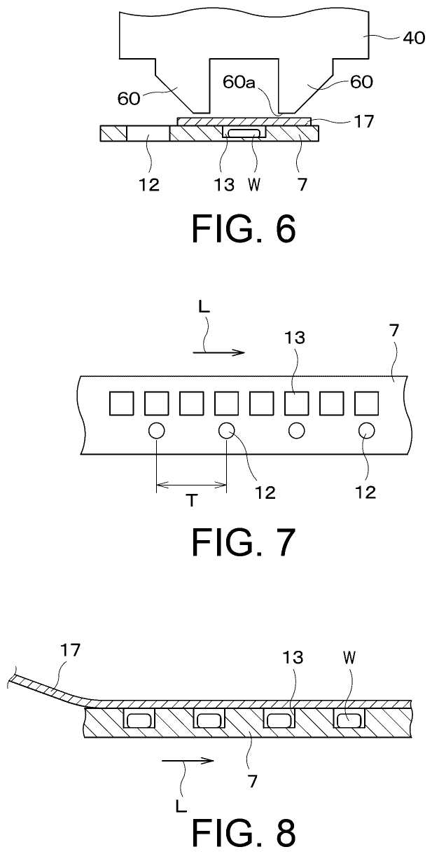

As shown in FIGS. 9 and 10, a workpiece taping system 1A includes: a part feeder 1 that aligns workpieces W (see FIG. 6) supplied thereto to face the same direction; a linear feeder 2 that receives the aligned workpieces from the part feeder 1 and transports them in a line; and a circular index table 3 that is horizontally placed. The index table 3 receives the workpieces W from the linear feeder 2, and is intermittently rotated by an action of a power source, not shown, in a direction of an arrow of FIG. 10 about a vertical rotation shaft 5. The index table 3 has, in its outer peripheral part, workpiece accommodation holes, not shown, which are opened outward. The workpieces W transported by the linear feeder 2 are individually accommodated in these workpiece accommodation holes. A separation supply unit 4 having a function of transferring the workpieces W from the linear feeder 2 into the workpiece accommodation holes of the index table 3 is provided between the linear feeder 2 and the index table 3.

In addition, a workpiece insertion unit 6 that transfers the workpieces W in the workpiece accommodation holes of the index table 3 to a carrier tape 7 is provided outside the index table 3.

Next, the carrier tape 7 is described with reference to FIGS. 7 and 8. FIG. 7 is a plan view showing the carrier tape, and FIG. 8 is a side view thereof. The carrier tape 7 has, close to its edge part, circular feed holes 12 that are regularly arranged along a transport direction L of the carrier tape 7. In addition, cavities 13 that are recesses for accommodating workpieces W in the workpiece insertion unit 6 are provided in the carrier tape 7. Since the feed holes 12 are used for positioning workpieces W when the workpieces W are inserted into the cavities 13, the feed holes 12 are arranged at equal intervals T to have a correlation with the cavities 13. FIG. 7 shows an example in which one feed hole is provided for two cavities.

The carrier tape 7 is made of paper as a whole. The cavities 13 are formed in the carrier tape 7 by punching the paper carrier tape 7.

The carrier tape 7 as structured above is supplied from a supply reel 8, and reaches the work insertion unit 6. In the work insertion unit 6, workpieces W are transferred into the cavities 13 of the carrier tape 7 to be accommodated therein, as described above. The carrier tape 7 with the workpieces W accommodated in the cavities 13 is then transported downstream (FIGS. 9 and 10).

Thereafter, a top tape 17 made of a synthetic resin is supplied to the carrier tape 7 with the workpieces W accommodated in the cavities 13, from a top-tape supply unit through guide rollers 17A, 17B. Then, the top tape 17 is thermally bonded to the carrier tape 7 with the workpieces W accommodated in the cavities 13 by a carrier-tape thermal bonding device according to the embodiment.

Thereafter, the carrier tape 7 to which the top tape 17 was thermally boded by the carrier-tape thermal bonding device 20 is sent to ARC (automatic reel changer) 10.

In FIGS. 9 and 10, a tape feed gear 9 for guiding the carrier tape 7 is provided directly below the work insertion unit 6.

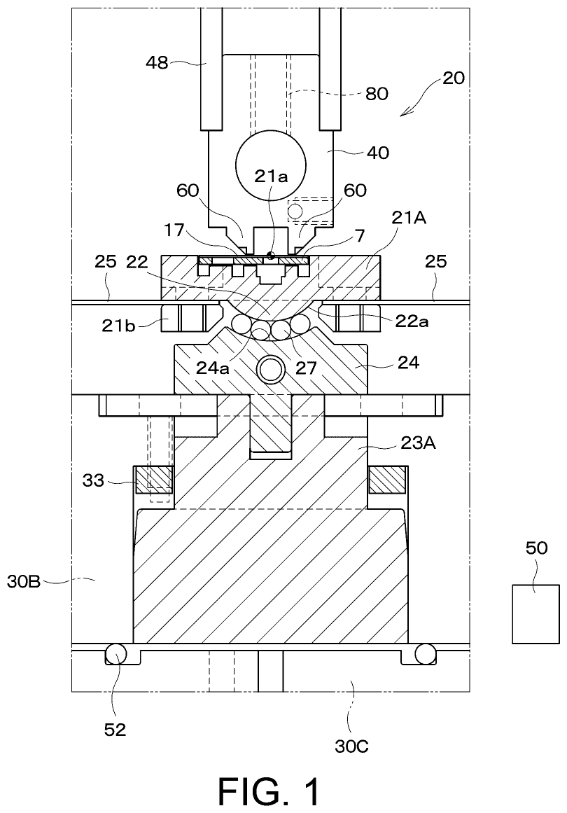

Next, the carrier-tape thermal bonding device 20 according to the embodiment is described with reference to FIGS. 1 to 6 and 11 to 14.

As shown in FIGS. 1 to 6 and 11 to 14, the carrier-tape thermal bonding device 20 is c to thermally bond the top tape 17 to the carrier tape 7 with the workpieces W accommodated in the cavities 13.

The carrier-tape thermal bonding device 20 includes: a lower cylinder block 30C connected to a base plate 30A described later; a cylinder block 30B provided above the lower cylinder block 30C; a pair of transport rails 21A, 21B that are provided on the cylinder block 30B to be movable upward and downward, as described later, and are configured to hold the carrier tape 7 and the top tape 17 in a stacked condition; and drive cylinders 23A, 23B that support the respective transport rails 21A, 21B and move the transport rails 21A, 21B upward and downward. The cylinder block 30B is provided above the lower cylinder block 30C through a silicon rubber 52. The base plate 30A, the cylinder block 30B and the lower cylinder block 30C form a stationary structure.

The carrier-tape thermal bonding device 20 includes the pair of transport rails 21A, 21B and the drive cylinders 23A, 23B that move the respective transport rails 21A, 21B upward and downward, as described above. The transport rail 21A of the transport rails 21A, 21B is positioned upstream in the transport direction L of the carrier tape 7, and the transport rail 21B is positioned downstream in the transport direction L. In addition, the drive cylinder 23A is positioned upstream in the transport direction L, and the drive cylinder 23B is positioned downstream in the transport direction L.

An elongated heating device 40 is positioned above the pair of transport rails 21A 21B to face the transport rails 21A, 21B. The heating device 40 heats and presses the top tape 17 along the transport direction L.

As shown in FIG. 1, the heating device 40 incorporates a heating unit 80 and is heated by this heating unit 80. The heating device 40 has a pair of heating elements 60 that are formed on a lower part thereof. The pair of heating elements 60, 60 are positioned to face the top tape 17 on both sides of a width direction of the cavity 13. A lower end surface 60a, 60a of each heating element 60, 60 has a width of 0.2 mm to 0.6 mm (see FIG. 6).

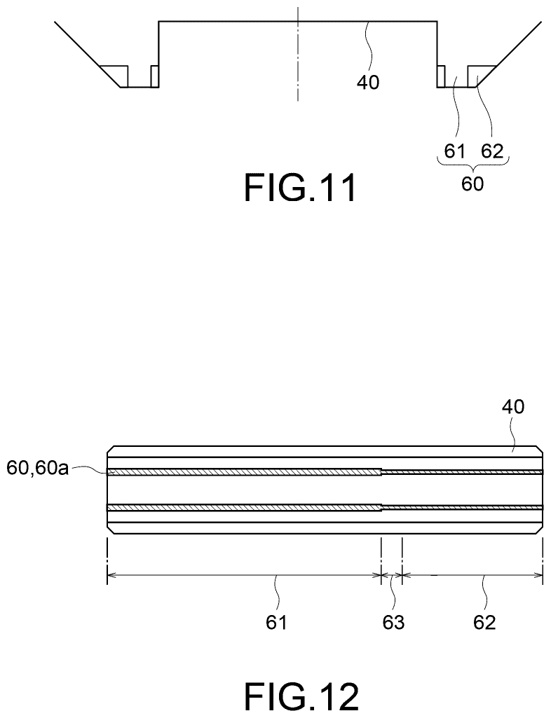

As shown in FIGS. 11 to 14, each of the pair of heating elements 60 of the heating device 40 is divided into a preheating area 61 and a pressurizing area 62 which are formed in this order from the upstream side to the downstream side along the transport direction L. A width (referred to also as width direction length) W1 of the lower end surface 60a of each heating element 60 in the preheating area 61 is greater than a width (referred to also as width direction length) W2 of the lower end surface 60a of each heating element 60 in the pressurizing area 62.

Specifically, the width W1 of the lower end surface 60a of the heating element 60 in the preheating area 61 is, for example, 0.4 mm to 0.6 mm, and the width W2 of the lower end surface 60a of the heating element 60 in the pressurizing area 62 is 0.2 to 0.4 mm (see FIG. 14).

As shown in FIG. 14, a transition area 63 having a curved outer shape is formed between the preheating area 61 and the pressurizing area 62 of each heating element 60 of the heating device 4.

In the carrier-tape thermal bonding device 20 as structured above, the pair of heating elements 60 in the preheating area 61 positioned upstream in the transport direction L, and the transport rail 21A and the drive cylinder 23B corresponding to the pair of heating elements 60 are configured to mainly preheat the carrier tape 7 and the top tape 17.

The pair of heating elements 60 in the pressurizing area 62 positioned downstream in the transport direction L, and the transport rail 21B and the drive cylinder 23B corresponding to the pair of heating elements 60 are configured to mainly pressurize the carrier tape 7 and the top tape 17.

As shown in FIG. 14, a centerline L1 of the lower end surface 60a of the heating element 60 in the preheating area 61 corresponds to a centerline L1 of the lower end surface 60a of the heating element 60 in the pressurizing area 62.

Namely, the lower end surface 60a of the heating element 60 has the center line L1 along the transport direction L. The transport direction L extends linearly over the heating area 61, the transition area 63 and the pressurizing area 62.

Since the width W1 of the lower end surface 60a of the heating element 60 in the preheating area 61 is greater than the width W2 of the lower end surface 60a of the heating element 60 in the pressurizing area 62, the carrier tape 7 and the top tape 17 are preheated first by the pair of heating elements 60 in the preheating area 61. Then, the top tape 17 can be pressurized to the carrier tape 7 at a higher pressure per unit area by the pair of heating elements 60 in the pressurizing area 62. This enables the top tape 17 to be thermally bonded to the carrier tape 7 rapidly and securely.

Namely, in the preheating area 61, the carrier tape 7 and the top tape 17 are preheated between the pair of heating elements 60 and the corresponding upstream transport rail 21A. Then, in the pressurizing area 62, the carrier tape 7 is thermally bonded to the top tape 17 between the pair of heating elements 60 and the corresponding downstream transport rail 21B. In this case, a pressuring force between the pair of heating elements 60 and the upstream transport rail 21A in the preheating area 61 and a pressurizing force between the pair of heating elements 60 and the downstream transport rail 21B in the pressurizing area 62 are set substantially the same with each other. Since the width W1 of the lower end surface 60a of the heating element 60 in the preheating area 61 is greater than the width W2 of the lower end surface 60a of the heating element 60 in the pressurizing area 62, the pair of heating elements 60 in the pressurizing area 62 can pressurize the top tape 17 to thermally bond to the carrier tape 7 with a higher pressure per unit area even for a short pressuring time.

Further, the centerline L1 present in the lower end surface 60a of the heating element 60 extends linearly along the preheating area 61, the transition area 63 and the pressurizing area 62. Thus, after the carrier tape 7 and the top tape 17 have been preheated by the heating elements 60, the preheated portions of the carrier tape 7 and the top tape 17 can be securely pressurized to be thermally bonded to each other. This enables the carrier tape 7 and the top tape 17 to be thermally bonded to each other easily and securely.

The heating device 40 including the pair of heating elements 60 is made of a copper-based material with good thermal conductivity, and a surface thereof is plated with hard chrome with high wear resistance.

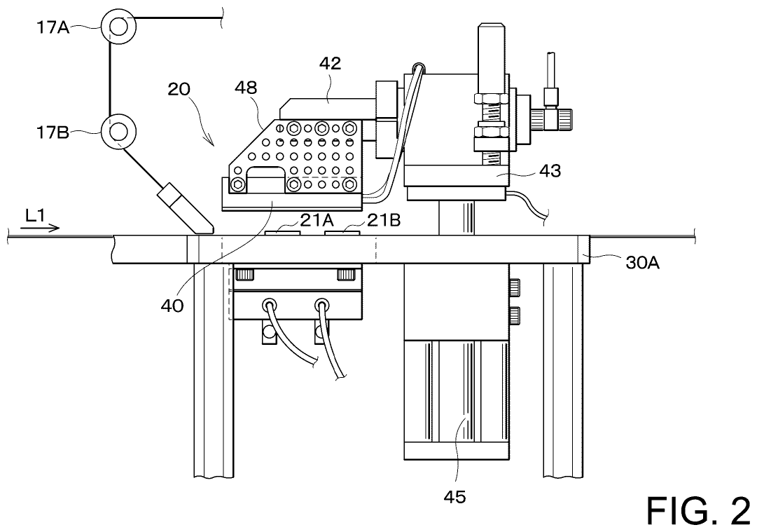

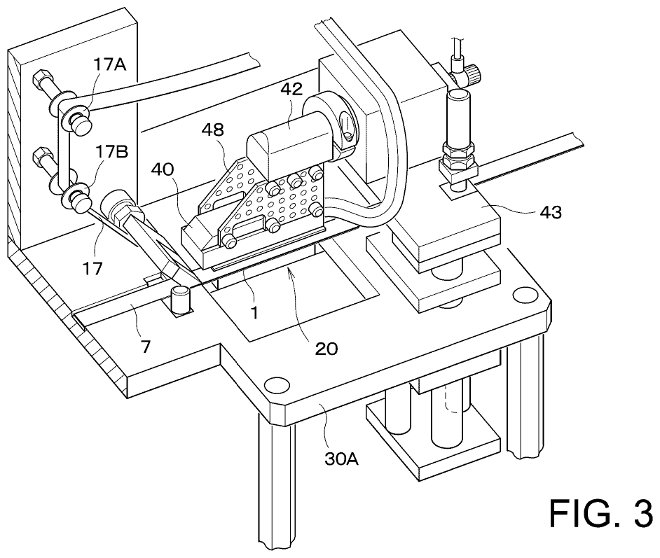

As shown in FIGS. 2 and 3, the heating device 40 is supported by a cover member 48 which is rotated about a rotation shaft 42 extending parallel to the transport direction L. The rotation shaft 42 rotatably supporting the heating device 40 is held by a holding device 43. The holding device 43 can be moved upward and downward by a heating-device cylinder 45 provided below the base plate 30A.

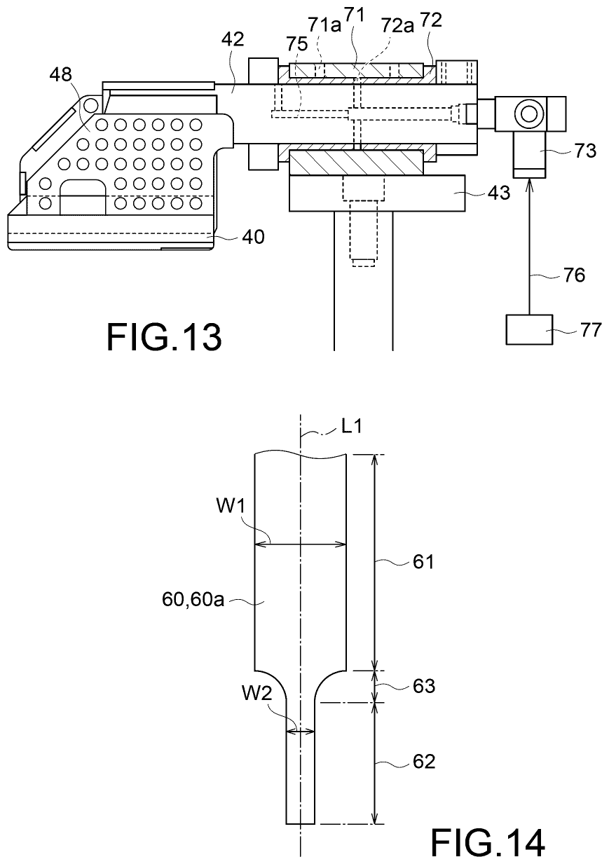

As described above, the heating device 40 is supported by the cover member 48 which is rotated about the rotation shaft 42 extending parallel to the transport direction L. The rotation shaft 42 is rotatably supported through a bearing 72 by a rotation-shaft holder 71 provided above the holding device 43 (see FIG. 13).

Namely, the rotation shaft 42 which supports the heating device 4 through the cover member 48 is held by the rotation-shaft holder 71. Thus, when the heating device 40 is heated, the heat is transferred from the heating device 40 to the rotation shaft 42 through the cover member 48.

In this embodiment, as shown in FIG. 13, a cooling channel 75 through which cooling air for cooling the rotation shaft 42 is provided within the rotation shaft 42, in order to prevent the heat from the heating device 40 from being transferred to the rotation shaft 42 to interfere with the rotation of the rotation shaft 42.

In FIG. 13, the rotation shaft 42 is rotatably supported by the rotation-shaft holder 71 through the bearing 72. A cooling-air supply unit 73 which supplies cooling air into the cooling channel 75 is provided on an end of the rotation shaft 42, which is opposite to the cover member 48. A cooling-air supply source 77 is connected to the cooling-air supply unit 73 through a cooling-air supply line 76.

The cooling channel 75 provided in the rotation shaft 42 extends along a longitudinal direction of the rotation shaft 42 to be in communication with an outlet port 71a of the rotation-shaft holder 71 from a communication port 72a of the bearing 72.

In FIG. 13, cooling air is supplied from the cooling-air supply unit 73 into the cooling channel 75 in the rotation shaft 42. The cooing air supplied into the cooling channel 75 flows longitudinally in the rotation shaft 42, and is then discharged outward from the communication port 72a of the bearing 72 through the outlet port 71a.

During this time, the rotation shaft 42 can be effectively cooled by the cooling air. Thus, there is no possibility that the rotation shaft 42 and the bearing 72 are excessively heated by the heat from the heating device 40, and that the rotation of the rotation shaft 42 is interfered with by the heat in the bearing 72.

The heating device 40 is rotatably held by the rotation-shaft holder 71 through the rotation shaft 42. Thus, by rotating heating device 40 about the rotation shaft 42, the heating device 40 can be rotated between an operation position in which the pair of heating elements 60, 60 face downward, and a standby position in which the pair of heating elements 60, 60 face transversely.

When maintenance and inspection of the carrier-tape thermal bonding device 20 are carried out, the holding device 43 is moved upward by the heating-device cylinder 45. Then, the heating device 40 is moved upward away from the transport rail 21A, 21B, and the heating device 40 is rotated at 90°. This allows the heating device 40 to be brought from the operation position in which the pair of heating elements 60, 60 face downward, to the standby position in which the pair of heating elements 60, 60 face transversely.

In this way, the lower end surfaces 60a, 60a of the pair of heating elements 60, 60 of the heating device 40 face transversely (horizontally), so that the lower end surfaces 60a, 60a can be visually inspected and cleaned.

In this embodiment, the terms “upward”, “downward” and “transversely” mean “upward”, “downward” and “transversely” when the carrier-tape thermal bonding device 20 according to this disclosure is installed as shown in FIG. 1.

Next, the transport rails 21A, 21B which hold the carrier tape 7 and the top tape 17 in a stacked condition, and the drive cylinders 23A, 23B provided correspondingly to the transport rails 21A, 21B are described.

The transport rail 21A and the drive cylinder 23A provided correspondingly to the transport rail 21A, and the transport rail 21B and the drive cylinder 23B provided correspondingly to the transport rail 21B have the same structures with each other. Thus, only the transport rail 21A and the drive cylinder 23A provided correspondingly to the transport rail 21A are described herebelow, but the transport rail 21B and the drive cylinder 23B provided correspondingly to the transport rail 21B have the same structures as the transport rail 21A and the drive cylinder 23A.

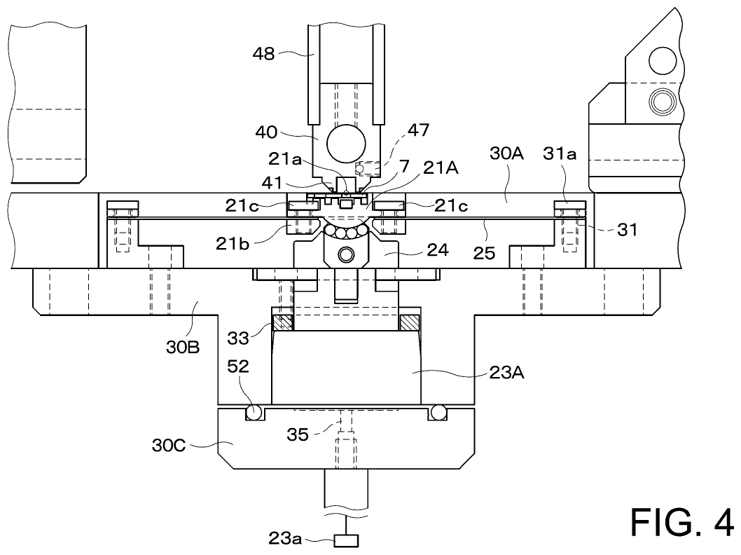

As shown in FIGS. 1 and 4, the transport rail 21A is configured to be moved upward and downward by the drive cylinder 23A as described above. An upper surface of the transport rail 21A is smoothened by applying thereto WPC treatment and DLC treatment (Diamond-Like-Carbon treatment). The WPC treatment herein means a process that forms a smooth micro-dimpled surface (surface on which air acts as lubricant) on the surface and also increases surface hardness of a material. The drive cylinder 23A, which is installed on the cylinder block 30B, drives the transport rail 21A upward and downward by air to move the transport rail 21A upward and downward at high speed, such as 8000 times per minute. In this embodiment, air is supplied to the drive cylinder 23A through a high-speed valve, not shown. A pressure sensor 23a is connected to the drive cylinder 23A. A drive stroke of the drive cylinder 23A is 0.1 mm to 0.3 mm. In this case, a pressurizing force of the drive cylinder 23A is 2 kgf to 6 kgf.

The transport rail 21A has at its lower end a lower end portion 22, and the drive cylinder 23A has at its upper end an upper end portion 24.

The upper end portion 24 of the drive cylinder 23A has a concave surface 24a which is curved and recessed downward when seen from the transport direction, and the lower end portion 22 of the transport rail 21A has a convex surface 22a which is curved and projecting downward when seen from the transport direction (see FIG. 1).

A plurality of rollers 27 are interposed between the concave surface 24a of the upper end portion 24 and the convex surface 22a of the lower end portion 22. Thus, the lower end portion 22 of the transport rail 21A is turned about a virtual center point 21a by the rollers 27 with respect to the upper end portion 24 of the drive cylinder 23A. The concave surface 24a of the upper end portion 24 and the convex surface 22a of the lower end portion 22 are buffed to increase smoothness of the concave surface 24a and the convex surface 22a.

As described above, the lower end portion 22 of the transport rail 21 can be turned about the virtual center point 21a with respect to the upper end portion 24 of the drive cylinder 23A. In this embodiment, when the top tape 17 is thermally bonded by the carrier-tape thermal bonding device 20, the heating device 40 is stationary, and the transport rail 21 is moved upward and downward by the drive cylinder 23. In this case, when a thickness and a density of the carrier tape 7 vary in the width direction (transverse direction orthogonal to transport direction in FIG. 1), there is a possibility that a pressurizing force onto the carrier tape 7 and the top tape 17 varies in the width direction between the transport rail 21A and the pair of heating elements 60, 60 of the heating device 40.

According to this embodiment, when the thickness and the density of the carrier tape 7 vary in the width direction (right and left direction perpendicular to transport direction in FIG. 1), the lower end portion 22 of the transport rail 21A can be turned about the virtual center point 21a with respect to the upper end portion 24 of the drive cylinder 23A. This allows the carrier tape 7 and the top tape 17 to be subjected to a uniform pressurizing force over the width direction between the transport rail 21A and the pair of heating elements 60, 60 of the heating device 40.

In FIG. 1, a direction perpendicular to a sheet plane is the transport direction of the carrier tape 7, and the transverse direction in FIG. 1 is the width direction of the carrier tape 7.

The transport rail 21A is supported on the upper end portion 24 of the drive cylinder 23A through the rollers 27. The transport rail 21A is supported on the cylinder block 30B through a pair of spring members 25 which are transversely arranged in FIG. 1.

Namely, as shown in FIG. 4, a support body 31 is provided above the cylinder block 30B, and one end of each spring member 25 is fixed on the support body 31 by a bolt 31a. The other end of each spring member 25 is sandwiched between the transport rail 21A and a support body 21b attached to a lower surface of the transport rail 21. The support body 21b is fixed to the transport rail 21A by a bolt 21c.

In this manner, the transport rail 21A is supported on the cylinder block 30B through the pair of spring members 25. Thus, if the thickness of the carrier tape 7 varies in the width direction so that the transport rail 21A is turned with respect to the drive cylinder 23A, the transport rail 21A is again turned with respect to the drive cylinder 23A by the pair of spring members 25 when the transport rail 21A is moved downward away from the pair of heating elements 60, 60 of the heating device 40. This allows the transport rail 21A to return to its original position, i.e., the horizontal position shown in FIG. 1.

As shown in FIGS. 1 and 4, the drive cylinder 23A is installed to be movable upward and downward with respect to the cylinder block 30, and an air pipe 35 which drives the drive cylinder 23A is provided in the cylinder block 30B.

In addition, the cylinder block 30B is provided with a resin stopper 33 for locking movement of the drive cylinder 23A.

An initial position of the transport rail 21A is defined by the pair of spring members 25 to take a horizontal position. When a height position of the transport rail 21A is desired to be changed, a spacer (not shown) can be inserted between the lower surface of the transport rail 21 and the spring member 25 to elevate the height position of the transport rail 21A close to the heating device 40.

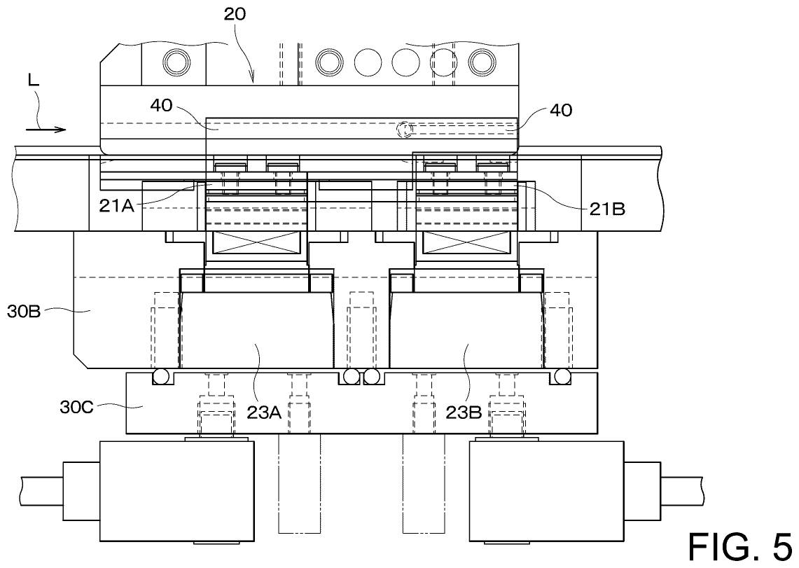

As shown in FIG. 5, the aforementioned carrier-tape thermal bonding device 20 has the pair of transport rails 21A, 21B which are arranged side by side in the transport direction L, and the pair of drive cylinders 23A, 23B provided correspondingly to the respective transport rails 21A, 21B.

In this case, each carrier-tape thermal bonding device 20 includes: the common cylinder block 30B; the pair of transport rails 21A, 21B that are provided on the common cylinder block 30B to be movable upward and downward and are configured to hold the carrier tape 7 and the top tape 17 in the stack condition; the heating device 40 that is provided above the transport rails 21A, 21B to be opposed to the transport rails 21A, 21B and is configured to heat and press the top tape 17; and the drive cylinders 23A, 23B that are configured to support the respective transport rails 21A, 21B and to move the transport rails 21A, 21B upward and downward.

Next, an operation of this embodiment as structured above is described.

An operation of the entire taping system is described first with reference to FIGS. 9 and 10. As shown in FIGS. 9 and 10, workpieces W supplied to the part feeder 1 are aligned to face the same direction by the part feeder 1, and then are transferred to the linear feeder 2. The workpieces W are transported in a line by the linear feeder 2 to reach the index table 3. Further, the workpieces W are individually inserted, by the separation supply unit 4, into the workpiece accommodation holes, not shown, provided in the index table 3.

The workpieces W accommodated in the workpiece accommodation holes are transported to a characteristic measurement unit, not shown, by intermittent rotation of the index table 3 in the direction of the arrow in FIG. 10. Then, various characteristics of the workpieces W are measured. A workpiece W judged to be defective by the measurement is ejected from a workpiece accommodation hole by a discharge function, not shown. A workpiece W judge to be acceptable remains accommodated in a workpiece accommodation hole, and is sent to reach the workpiece insertion unit 6 by the intermittent rotation of the index table 3.

The carrier tape 7 wound around the supply reel 8 is transported from the tape feed gear 9 installed directly below the workpiece insertion unit 6, to the ARC 10. In this case, the tape feed gear 9 has teeth provided on its outer circumference, and the teeth are inserted into the feed holes 12 of the carrier tape 7, and the carrier tape 7 wound around the supply reel 8 is transported.

When the tape feed gear 9 is intermittently rotated, the carrier tape 7 reaches the workpiece insertion unit 6 and stops there. When the workpieces W are ready to be transferred, the carrier tape 7 is placed in position for transferring the workpieces W to the cavities 13 of the carrier tape 7. After the carrier tape 7 has been placed in position, the workpieces W in the workpiece accommodation holes in the index table 3 are transferred into the cavities 13 in the carrier tape 7.

Then, the synthetic resin top tape 17 is supplied to the carrier tape 7 with the workpieces W accommodated in the cavities 13, from the top-tape supply unit through the guide rollers 17A, 17B. Then, the top tape 17 is thermally bonded to the carrier tape 7 in the carrier-tape thermal bonding device 20.

The carrier tape 7 and the top tape 17, which are held in a stacked condition, are first transported on the upstream transport rail 21A.

At this time, a distance between the top tape 17 on the transport rail 21A and the pair of heating elements 60, 60 of the heating device 40 is maintained at around 0.1 mm.

Then, the upstream drive cylinder 23A is controlled by the control unit 50 such that the the drive cylinder 23A is driven upward to elevate the upstream transport rail 21A. This allows the carrier tape 7 and the top tape 17 to be sandwiched and pressurized between the upstream transport rail 21A and the pair of heating elements 60, 60 of the heating device 40. At the same time, the top tape 17 is heated by the heating elements 60 of the heating device 40.

During this time, the heating device 40 remains at a predetermined height position without moving upward or downward. A heating temperature of the heating device 40 is measured by a thermocouple 47, and the heating temperature measured by the thermocouple 47 is transmitted to the control unit 50. The control unit 50 adjusts the heating temperature of the heating unit 80 incorporated in the heating device 40. In addition, the control unit 50 adjusts air pressure supplied to the drive cylinder 23A based on a signal from a pressure sensor 23a connected to the drive cylinder 23A, so as to control a pressurizing force and a pressurizing time of the drive cylinder 23A.

The upstream transport rail 21A and the heating elements 60, 60 of the heating device 40, which are present in the preheating area 61 corresponding to the transport rail 21A, mainly preheat the carrier tape 7 and the top tape 17. A heating temperature of the heating device 40 is 140° C. to 190° C., a pressuring force of the drive cylinder 23A is 2 kgf to 6 kgf, and a pressurizing time is 1 millisecond to 10 milliseconds. Thereafter, the drive cylinder 23A is driven downward by the control unit 50 to lower the transport rail 21A.

In this manner, the thermal bonding operation to the carrier tape 7 and the top tape 17 by the upstream transport rail 21A and the heating elements 60, 60 of the heating device 40, which are present in the preheating area 61, is ended, and the carrier tape 7 is transported to the downstream transport rail 21B and the heating elements 60, 60 of the heating device 40, which are present in the pressurizing area corresponding to the transport rail 21B.

While the carrier tape 7 and the top tape 17 are thermally bonded to each other between the transport rail 21A and the pair of heating elements 60, 60 of the heating device 40, the carrier tape 7 may vary in its thickness and density in the width direction. In this case, since the lower end portion 22 of the transport rail 21A is turned about the virtual center point 21a with respect to the upper end portion 24 of the drive cylinder 23A, the carrier tape 7 and the top tape 17 can be subjected to a uniform pressurizing force over the width direction between the transport rail 21A and the pair of heating elements 60, 60 of the heating device 40.

When the drive cylinder 23A is driven downward to lower the transport rail 21A, the transport rail 21 is again turned by the pair of spring members 25 with respect to the drive cylinder 23A, whereby the transport rail 21A returns to its original position.

Then, the carrier tape 7 and the top tape 17, which are held in the stacked condition, are transported on the downstream transport rail 21B.

At this time, a distance between the top tape 17 on the transport rail 21B and the pair of heating elements 60, 60 of the heating device 40 is maintained at around 0.1 mm.

Then, the downstream drive cylinder 23B is controlled by the control unit 50 such that the drive cylinder 23B is drive upward to elevate the downstream transport rail 21B. This allows the carrier tape 7 and the top tape 17 to be sandwiched and pressurized between the downstream transport rail 1B and the pair of heating elements 60, 60 of the heating device 40, and simultaneously therewith, the top tape 17 is heated by the heating elements 60 of the heating device 40.

During this, the heating device 40 remains at a predetermined height position without moving upward or downward. A heating temperature of the heating device 40 is measured by the thermocouple 47, and the heating temperature measured by the thermocouple 47 is transmitted to the control unit 50. The control unit 50 adjusts the heating temperature of the heating device 40 of the heating unit 80 incorporated in the heating device 40. In addition, the control unit 50 adjusts air pressure supplied to the drive cylinder 23B based on a signal from a pressure sensor 23a connected to the drive cylinder 23B, so as to control a pressurizing force and a pressurizing time of the drive cylinder 23B.

The downstream transport rail 21B and the heating elements 60, 60 of the heating device 40, which are present in the pressurizing area 62 corresponding to the transport rail 21B, mainly pressurize the carrier tape 7 and the top tape 17. A heating temperature of the heating device 40 is 140° C. to 190° C., a pressuring force of the drive cylinder 23B is 2 kgf to 6 kgf, and a pressurizing time is 1 millisecond to 10 milliseconds. Thereafter, the drive cylinder 23B is driven downward by the control unit 50 to lower the transport rail 21B.

In this manner, the thermal bonding operation to the carrier tape 7 and the top tape 17 is ended, and the carrier tape 7 is further transported downstream.

While the carrier tape 7 and the top tape 17 are thermally bonded to each other between the transport rail 21B and the heating elements 60, 60 of the heating device 40, the carrier tape 7 may vary in its thickness and density in the width direction. In this case, since the lower end portion 22 of the transport rail 21B is turned about the virtual center point 21a with respect to the upper end portion 24 of the drive cylinder 23B, the carrier tape 7 and the top tape 17 can be subjected to a uniform pressurizing force over the width direction between the transport rail 21B and the pair of heating elements 60, 60 of the heating device 40.

When the drive cylinder 23B is driven downward to lower the transport rail 21B, the transport rail 21B is again turned by the pair of spring members 25 with respect to the drive cylinder 23B, whereby the transport rail 21B returns to its original position.

During this time, since the width W1 of the lower end surface 60a of the heating element 60 in the preheating area 61 is greater than the width W2 of the lower end surface 60a of the heating element 60 in the pressurizing area 62, the carrier tape 7 and the top tape 17 are preheated first by the pair of heating elements 60 in the preheating area 61. Then, the top tape 17 can be pressurized onto the carrier tape 7 at a higher pressure per unit area by the pair of heating elements 60 in the pressurizing area 62. This enables the top tape 17 to be thermally bonded to the carrier tape 7 rapidly and securely.

Further, since the centerline L1 present in the lower end surface 60a of the heating element 60 extends linearly along the preheating area 61, the transition area 63 and the pressurizing area 62, the heating element 60 preheats the carrier tape 7 and the top tape 17. Thereafter, the preheated portions of the carrier tape 7 and the top tape 17 can be securely pressurized to be thermally bonded to each other. This enables the carrier tape 7 and the top tape 17 to be thermally bonded to each other easily and securely.

After that, the carrier tape 7 to which the top tape 17 has been thermally bonded by the carrier-tape thermal bonding device 20 is sent to the ARC 10.

When maintenance and inspection of the carrier-tape thermal bonding device 20 are carried out, the holding device 43 is moved upward by the heating-device cylinder 45 to move the heating device 40 upward away from the transport rail 21, and then the heating device 40 is rotated at 90° through the rotation shaft 42. This allows the pair of heating elements 60, 60 of the heating device 40 to face transversely (horizontally). The lower end surfaces 60a, 60a of the pair of transversely facing heating elements 60, 60 of the heating device 40 can be easily and securely cleaned. The thermal bonding device 20, the transport rails 21A, 21B, the carrier tape 7 and the top tape 17 are arranged parallel to each other along the transport direction L.

As described above, according to this embodiment, the carrier-tape thermal bonding device 20 includes: the elongated heating device 40 arranged along the transport direction L of the carrier tape 7, and the pair of transport rails 21A, 21B. The carrier tape 7 and the top tape 17 are preheated between the pair of heating elements 60, 60, which are present in the preheating area 61 positioned upstream of the heating device 40, and the upstream transport rail 21A. Then, the carrier tape 7 and the top tape 17 are pressurized to be thermally bonded to each other between the pair of heating elements 60, 60, which are present in the pressurizing area positioned downstream of the heating device 40, and the downstream transport rail 21B. Namely, the pair of heating elements 60, 60 in the preheating area 61 and the transport rail 21A have a preheating function, and the pair of heating elements 60, 60 in the pressurizing area 62 and the transport rail 21B have another function, i.e., a pressurizing function. This enables a rapid and precise thermal bonding operation as compared with a structure in which a single carrier-tape thermal bonding device 20 has both a heating function and a pressurizing function. In addition, since the thermal bonding device 20, the transport rails 21A, 21B, the carrier tape 7 and the top tape 17 are arranged parallel to each other along the transport direction L, thermal bonding can be performed to the carrier tape 7 and the top tape 17 repeatedly and uniformly. Thus, desired peeling strength can be obtained by repeatedly performing thermal bonding for a short time on the carrier tape 7 and the top tape 17 during high-speed processing.

Since the width W1 of the lower end surface 60a of the heating element 60 of the preheating area 61 is greater than the width W2 of the lower end surface 60a of the heating element 60 of the pressurizing area 62, the carrier tape 7 and the top tape 17 are preheated first by the pair of heating elements 60 in the preheating area 61. Then, the top tape 17 can be pressurized onto the carrier tape 7 at a high pressure by the pair of heating elements 60 in the pressurizing area 62, so that the top tape 17 can be thermally bonded to the carrier tape 7 rapidly and securely. This can achieve desired peeling strength to be obtained between the carrier tape and the top tape 17.

In addition, since the centerline L1 present in the lower end surface 60a of the heating element 60 extends linearly along the preheating area 61, the transition area 63 and the pressurizing area 62, the carrier tape 7 and the top tape 17 are preheated by the heating elements 60, and then the preheated portions of the carrier tape 7 and the top tape 17 can be securely pressurized to be thermally bonded to each other. For example, firstly the carrier tape 7 and the top tape 17 is heated by the preheating area 61 with a width of 0.5 mm, and then the central portion of the carrier tape 7 and the top tape 17 with a width of 0.3 mm which is the hottest, can be heated again by the pressuring area 62. In this case, since the top tape 17 is heated by the preheating area 61 with a width of 0.5 mm, and the central portion of the top tape 17 with a 0.3 mm is heated again by the pressuring area 62, the adhesion portion of the central portion of the top tape 7 can be forcibly pushed into the carrier tape 7. As a result, the carrier tape 7 and the top tape 17 can be securely and thermally bonded.

Further, as described above, the rotation shaft 42 supporting the heating device 40 can be effectively cooled by cooling air. Thus, there is no possibility that the rotation shaft 42 and the bearing 72 are excessively heated by the heat from the heating device 40, and that the rotation of the rotation shaft 42 is interfered with by the heat in the bearing 72.

In addition, when maintenance and inspection of the carrier-tape thermal bonding device 20 are carried out, the heating device 40 is rotated at 90° through the rotation shaft 42 so that the pair of heating elements 60, 60 of the heating device 40 face transversely (horizontally). Thus, the lower end surfaces 60a, 60a of the pair of transversely facing heating elements 60, 60 of the heating device 40 can be easily and securely cleaned.

During the operation of the carrier-tape thermal bonding device 20, the transport rails 21A, 21b move upward and downward to thermally bond the top tape 17 to the carrier tape 7, while the heating device 40 does not move upward or downward. This eliminates the need to apply a large impact load to the carrier tape 7, and thus no large noise is generated as compared with a structure in which the heating device 4 is swung down to thermally bond the carrier tape 7 and the top tape 17 to each other.

Even when the carrier tape 7 varies in its thickness and density in the width direction, the lower end portion 22 of the transport rail 21A, 21B can be turned about the virtual center point 21a with respect to the upper end portion 24 of the drive cylinder 23A, 23B, whereby the carrier tape 7 and the top tape 17 can be subjected to a uniform pressurizing force over the width direction between the transport rail 21A, 21B and the pair of heating elements 60, 60 of the heating device 40.

After the drive cylinder 23A, 23B has been driven downward to lower the transport rail 21A, 21B, the transport rail 21 can be returned to its original position by the pair of spring members 25.

Furthermore, since a pressurizing force and a pressurizing time of the drive cylinders 23A, 23B can be controlled by the control unit 50, the upstream drive cylinder 23A can be operated under conditions suitable for preheating, and the downstream drive cylinder 23B can be operated under conditions suitable for pressurizing.

In the aforementioned embodiment, a paper carrier tape is used as the carrier tape 7, and the carrier tape 7 is punched to form therein the cavities, for example. However, the embodiment is not limited thereto, and it is possible to form cavities 13 in the paper carrier tape 7 by forming through holes in the carrier tape 7 and attaching a bottom tape onto a lower surface of the carrier tape 7.

Alternatively, a synthetic resin carrier tape may be used as the carrier tape 7, which have embosses and flanges provided at tops of the embosses formed by a synthetic resin sheet.
1 Part feeder
2 Linear feeder
3 Index table
4 Separation supply unit
5 Rotation shaft
6 Workpiece insertion unit
7 Carrier tape
8 Supply reel
9 Tape feed gear
10 ARC
12 Feed hole
13 Cavity
20 Carrier-tape thermal bonding device
21A, 21B Transport rail
22 Lower end portion
22a Convex surface
23A, 23B Drive cylinder
24 Upper end portion
24a Concave surface
25 Spring member
27 Roller
30A Base plate
30B Cylinder block
40 Heating device
42 Rotation shaft
48 Cover member
50 Control unit
60 Heating element
60a Lower end surface
61 Preheating area
62 Pressurizing area
63 Transition area
71 Rotation-shaft holder
71a Outlet port
72 Bearing
72a Communication port
73 Cooling-air supply unit
75 Cooling air channel
76 Cooling-air supply line
77 Cooling-air supply source

1. A carrier-tape thermal bonding device that thermally bonds a top tape to a carrier tape including a cavity inside which a workpiece is accommodated, the carrier tape extending in a transport direction, the carrier-tape thermal bonding device comprising:
a transport rail that is configured to hold the carrier tape and the top tape in a stacked condition and includes a lower end portion;
a heating device that is arranged above the transport rail to be opposed to and parallel to the transport rail and is configured to heat and press the top tape; and
a pneumatic drive unit that has an upper end portion for supporting the lower end portion of the transport rail and is configured to move the transport rail upward and downward;
wherein:
the upper end portion of the drive unit has a concave surface that is curved when seen from the transport direction, the lower end portion of the transport rail having a convex surface that is curved when seen from the transport direction, and a plurality of rollers being interposed between the concave surface and the convex surface;
the heating device includes at a lower end portion thereof a pair of heating elements positioned on both sides of a width direction of the cavity;
the pair of heating elements are each divided into a preheating area and a pressurizing area formed in this order from an upstream side to a downstream side along the transport direction; and
a length in the width direction of the preheating area of each heating element is greater than a length in the width direction of the pressurizing area.

2. The carrier-tape thermal bonding device according to claim 1, wherein
a centerline of the preheating area along the transport direction of each heating element corresponds to a centerline of the pressurizing area along the transport direction.

3. The carrier-tape thermal bonding device according to claim 1, wherein
a length in the transport direction of each of the pair of heating elements present in the preheating area is longer than a length in the transport direction of each of the pair of heating elements present in the pressurizing area.

4. The carrier-tape thermal bonding device according to claim 1, wherein
the heating device is supported to be rotatable about a rotation shaft extending parallel to the transport direction, so that the heating device is rotatable between an operation position in which the pair of heating elements face downward, and a standby position in which the pair of heating elements face transversely.

5. The carrier-tape thermal bonding device according to claim 4, wherein
a cooling channel that cools the rotation shaft is formed in the rotation shaft.
